(19) United States
(12) Patent Application Publication
(10) Pub. No.: US 2014/0030432 A1
(43) Pub. Date: Jan. 30, 2014

(54) Method for Making Porous Materials

(71) Applicant: National Chiao Tung University, Hsinchu City (TW)

(72) Inventors: Jih-Perng LEU, Taipei City (TW); Yu-Han CHEN, Kaohsiung City (TW)

(21) Appl. No.: 13/915,491

(22) Filed: Jun. 11, 2013

(30) Foreign Application Priority Data
Jul. 25, 2012 (TW) 101126766

(51) Int. Cl. C09D 5/00

(52) U.S. Cl. CPC C09D 5/00
USPC 427/243

(57) ABSTRACT

A method for manufacturing a porous material is disclosed, which comprises the following steps: providing a substrate; coating the substrate with a precursor solution to form a precursor film, wherein the precursor solution includes a precursor compound, a porogen, and a solvent, and the porogen is modified by a surface modification to have an absolute surface electric potential of >25 mV; and treating the precursor film with a thermal curing profile to remove the porogen and form a porous material.

### CROSS-REFERENCE TO RELATED APPLICATION

This application claims the benefits of the Taiwan Patent Application Serial Number 101126766, filed on Jul. 25, 2012, the subject matter of which is incorporated herein by reference.

### BACKGROUND OF THE INVENTION

1. Field of the Invention

The present invention relates to a method for preparing a porous material, especially a method for preparing a porous material having densely distributed pores of a regular shape and a uniform size.

2. Description of Related Art

Porous materials play an integral role in scientific research and industrial development. Its unique and promising features such as high specific surface area, high absorption property, high reactivity, potential use as dielectric material, heat insulator material, and separating material etc. make porous material applicable for a great number of technical situations, such as application as a semiconductor, low-dielectric-constant material (such as interlayer dielectric (ILD), inter-metal dielectric (IMD), pre-metal dielectric (PMD), and dielectric for shallow trench isolation (STI)), fuel cell, gas sensor, and photoelectric component.

Numerous methods for forming porous materials are already known in the general knowledge of this field of technology, of which it is well known to add porogens in a base material, form a two phased material by way of spin-on or chemical vapor deposition (CVD), or plasma-enhanced chemical vapor deposition (PECVD), and use heat treatment to remove porogens in order to prepare a porous material. However, a known problem in this existing art with the porous material is difficulty in controlling pore shape and pore size, because severe aggregation of porogens will occur when a temperature is higher than the glass transition temperature of the base material or when viscosity decreases. The issue of severe aggregation can further develop into oversized pore distribution during the heat removal process, and interconnection between two pores may also occur. Furthermore, desired pore size and uniformly distributed pores can only become possible if high curing rate is used in the aforementioned method for the purpose of heat curing. However, rapid temperature increase for removing porogens can cause the material to be more easily exposed to damage by thermal stress, causing undesirable distortion to material structure.

Therefore, there is currently a need in the market for a method for preparing porous materials that can serve the interest of making porous materials with densely distributed pores, wherein the pores have a regular shape, and uniform size.

### SUMMARY OF THE INVENTION

An object of the present invention is to provide a porous material preparation method, capable of forming porous materials having pores with regular shape, uniform size, and tight distribution.

In order to achieve the above object, the present application offers herein an invention relating to a porous material preparation method, comprising the steps of the following: (A) providing a substrate; (B) coating or depositing a precursor solution on the substrate to form a precursor film; wherein, the precursor solution comprises a precursor compound, a porogen, and a solvent, and the porogen is treated with surface modification to have an absolute value of surface potential greater than 25 mV; and (C) heat curing the precursor film, and removing the porogen so as to form a porous material.

In the preparation method of the present invention, the kind of precursor compound is unlimited, and can be selected depending on a porous material as required. For instance, if a porous material with a low dielectric constant is required, the precursor compound may be a low dielectric constant matrix precursor (low-k matrix precursor). Alternatively, if a porous material of metal catalyst is required, the precursor may be a metal catalyst precursor.

Next, the low-k matrix precursor and the metal catalyst precursor are not limited, and can be prepared by using any known synthetic method. Herein, the low-k matrix precursor is preferred to be selected from the group consisting of methyl silsesquioxane (MSQ), poly methyl. Silsesquioxane (PMSSQ), poly silsesquioxane, benzene and biphenylene-bridged silsesquioxane, 1,2-bis(triethoxysilyl)ethane (BTESE), methyl triethoxysilane (MTES), and alkoxysilane. Among them, it is more preferred to use methyl silsesquioxane (MSQ).

Moreover, the porogen is not particularly limited, and a porogen used by any known art can be used. It is more preferred to select from the group consisting of a polymer having low decomposition temperature (low T_{d}), a polymer having high decomposition temperature (high T_{d}), a dendrimer, an amphiphilic linear polymer, a star-shape polymer, a hyperbranched polymer, and a cage supramolecule. Among them, it is more preferred to use polymer having high decomposition temperature.

In a more specific term, the porogen is preferably selected from the group consisting of polymethylmethacrylate (PMMA), polystyrene (PS), ethyl acrylate-terminated polypropylenimine, polymethylmethacrylate-poly(2-dimethylaminoethyl methacrylate) (PMMA-PDMAEMA), polyethylene oxide)-poly(propylene oxide)-poly(ethylene oxide) (PEO-PPO-PEO), polystyrene-poly(styrene-β-2-vinyl pyridine) (PS-P2VP), poly(e-caprolactone) (PLC), and cyclodextrin (CDs). It is more preferred to select polystyrene (PS). By means of the foregoing, it is possible to select a porogen molecular weight in accordance with pore size as required, for which the pore of the porous materiel formed thereof will be larger when the porogen molecular weight used is larger.

In the preparation method of the present invention, the solvent can be selected from the group consisting of tetrahydrofuran (THE), butanol, ethylene glycol, toluene, methyl isobutyl ketone (MIBK), dimethylformamide, ethanol, hexane, chloroform, and acetone, but it is not particularly limited herein, as it is merely required to be able to cause precursor and porogen to completely dissolve and leave no phase separation at room temperature. It is more preferable to use tetrahydrofuran (THF) as the solvent.

In the preparation method of the present invention, the surface modification treatment can be executed with an acidic solution, a basic solution, or a surfactant. The surfactant can be selected from a cationic surfactant, or an anionic surfactant. Herein, the cationic surfactant is not limited, and is preferred to be domiphen bromide (DB), or hexadecyl trimethyl ammonium bromide; it is even more preferred to be domiphen bromide (DB). Similarly, the anionic surfactant is not limited, it is preferred to be selected from sodium dodecylbenzene sulfonate (NaDBS), sodium dodecyl sulfate (SDS), or sodium lauryl sulfate (SLS); it is more preferred to be sodium dodecylbenzene sulfonate (NaDBS).

After the porogen is treated with surface modification, the absolute value of the surface potential of porogen will be increased to be above 25 mV, which is preferred to be between 50 mV and 70 mV. Such increase in the absolute value of the surface potential can cause formation of electrostatic repulsion force between the porogen, and in turn, stabilize porogen and enable uniform porogen distribution during dispersing porogen in the precursor solution and the precursor film, and maintain favorable porogen distribution ability during slow heating.

In step (C) of the preparation method of the present invention, the heat curing process is not particularly limited, and can use a temperature higher than the decomposition temperature of the porogen to rapidly cure the precursor film. Alternatively, the temperature can be raised to the decomposition temperature of the porogen with low heating rate (such as 2° C. per minute) so as to slowly cure the precursor film. The present invention can produce a porous material having densely distributed pores regardless of any heating rate.

Furthermore, in step (B) of the present invention, it will be understood to a person having ordinary skill in the art to form the dielectric film by any known technical method. The method herein can be spin coating, dipping, blade coating, spray coating, printing, or roller coating. As compared to using chemical phase deposition (CVD), or plasma enhanced chemical vapor deposition as a means for introducing porogen and low dielectric material to deposit the low-k film, the spin coating, dipping, blade coating, spray coating, printing, or roller coating, etc. used in the present invention does not require complex equipments and processes.

As a result, in step (A) of the preparation method of the present invention, the substrate is not limited, and it is merely required to take into consideration whether the substrate will be affected following the high temperature curing process.

Because the material can trap air having dielectric constant of 1 inside the pores in the material, the porous material marked by present invention can exhibit a reduced dielectric constant. Higher pore number means lower dielectric constant of the material, and also means less dielectric loss, which of all means for electric isolation. Moreover, thermal conduction and diffusion of material can be weakened as a result of increasing pore number; this can function to isolate heat for the porous material.

In comparison against the prior known technology, it is not necessary for the preparation method of the invention to be limited to condition of heat curing as set up by rapid heating, and pore size control is possible. Therefore, it is possible with the preparation method of the present invention to produce a porous material having densely distributed pores of regular shape and uniform size, by the use of simple surface modification process for increasing surface potential of porogens.

### BRIEF DESCRIPTION OF THE DRAWINGS

FIG. 1A illustrates a relationship between porogen size and temperature for non-modified porogen in accordance with an embodiment of the present invention.

FIG. 1B illustrates a relationship between porogen size and temperature for NaDBS modified porogen in accordance with an embodiment of the present invention.

FIG. 1C illustrates a relationship between porogen size and temperature for DB modified porogen in accordance with an embodiment of the present invention.

FIG. 2A shows experimental result of thin film viscosity for a preferred embodiment of the present invention.

FIG. 2B shows experimental result of thin film porogen size for a preferred embodiment of the present invention.

FIG. 2C shows experimental result of network/cage degree for a preferred embodiment of the present invention.

FIG. 3 is a graph showing change in Si—OH infrared absorption band of the thin film for a preferred embodiment of the present invention.

FIG. 4A is a graph showing experimental result of peak position for Si—OH absorption band for a preferred embodiment of the present invention.

FIG. 4B is a graph showing experimental result of peak intensity for Si—OH absorption band for a preferred embodiment of the present invention.

### DETAILED DESCRIPTION OF THE PREFERRED EMBODIMENT

### Preparative Example 1

### Porogen Modified by Acid/Base

PS particles (purchased from Sigma-Aldrich, M_{w}=790 g/mole) were added to and uniformly dispersed in THF to form a PS/THF solution (pH value being approximately 7.0).

Then, PS solutions with pH values of 3 and 11 were prepared by adding acid and base, respectively.

### Preparative Example 2

### Porogen Modified by Surfactant

The PS/THF solution (of which pH being approximately 7) was prepared using the same method as in Preparative Example 1. Then, the PS particles were modified by anionic surfactant NaDBS (purchased from Showa Chemical Industrial Company, M_{w}=348.48, of which critical micelle concentration, CMC, being 522.75 mg/L) and cationic surfactant DB (purchased from Sigma-Aldrich, M_{w}=414.48 CMC=730.74 mg/L) below their CMC, respectively.

### Example 1

First, the zeta potentials of the PS particles prepared in Preparative Examples 1 and 2 were measured using a zeta potential analyzer (Zetasizer HSA 3000, purchased from Malvern Instruments), and the size of the PS particles in THF was measured using an ultrafine particle analyzer (Honeywell UPA 150).

Next, MSQ (purchased from Gelest) and PS particles (with and without surface modification) at 10 wt % loading were added to THF so as to form a low-k precursor solution. The low-k solution was filtered through a 0.20 gm PTFE filter (purchased from Millipore), and then spun onto a silicon wafer at 2000 rpm for 30 seconds under room temperature to obtain a 500 nm thick thin film. Lastly, the film was cured in a quartz tube furnace under N₂ at a heating rate of 2° C./min to 400° C. for 1 hour to form a porous material after completely burning out the porogens.

### [Property Evaluation]

The size and distribution of the porogen in the film during the curing step were characterized by in situ Grazing-Incidence Small-Angle X-ray Scattering (in situ GISAXS). In situ 2D GISAXS data were collected from 30 to 200° C. All of the GISAXS data were obtained using a 2D area detector covering a q range from 0.01 to 0.1 Å⁻¹, and the incident angle of the X-ray beam (0.5 mm diameter, 10 keV energy) was fixed at 0.2°. Then, the porogen size was analyzed using sphere-model fitting and Guinier's law.

Further, the pore size of the film was characterized using the GISAXS technique. The porosity of the film was obtained by X-ray reflectivity (XRR) (Bruker D8 Discover) with a Cu K_{α} source (λ=0.154 nm) using ω-2θ scan mode. The scanning region ranged from 0° to 2′, and the XRR data was analyzed by LEPTOS simulation software.

The viscosity between MSQ and PS was examined from room temperature to 200 V; for the film by an Advanced Rheometric Expansion System (ARES, Rheometric Scientific). The interaction between MSQ and PS was further investigated using a FTIR spectrometer (MAGNA-IR 460, Nicolet Inc.).

Table 1 below summarizes the zeta potential and the corresponding particle size of PS porogen in the solution with and without modification. Accordingly, it can be confirmed that the larger absolute value of potential results in a smaller PS particle size under the same curing condition. In addition, Table 1 shows that the particle sizes of PS modified by anionic and cationic surfactants were further reduced to 9.0 nm and 8.0 nm because of their relatively higher absolute surface potential, respectively.

TABLE 1

| PS | Zeta Potential (mV) | PS Particle Size (nm) |
|---|---|---|
| No Modification | −18 | 49.3 |
| PH = 3 | +28 | 12.3 |
| PH = 11 | −40 | 11.2 |
| Anionic Surfactant | −58 | 9.0 |
| NaDBS | | |
| Cationic Surfactant DB | +66 | 8.0 |

From the 2D GISAXS data (not shown in the figure), it can be found that the PS porogens without modification tended to aggregate and did not disperse well in the film. In contrast, the PS porogens modified by NaDBS and DB were dispersed well in the film.

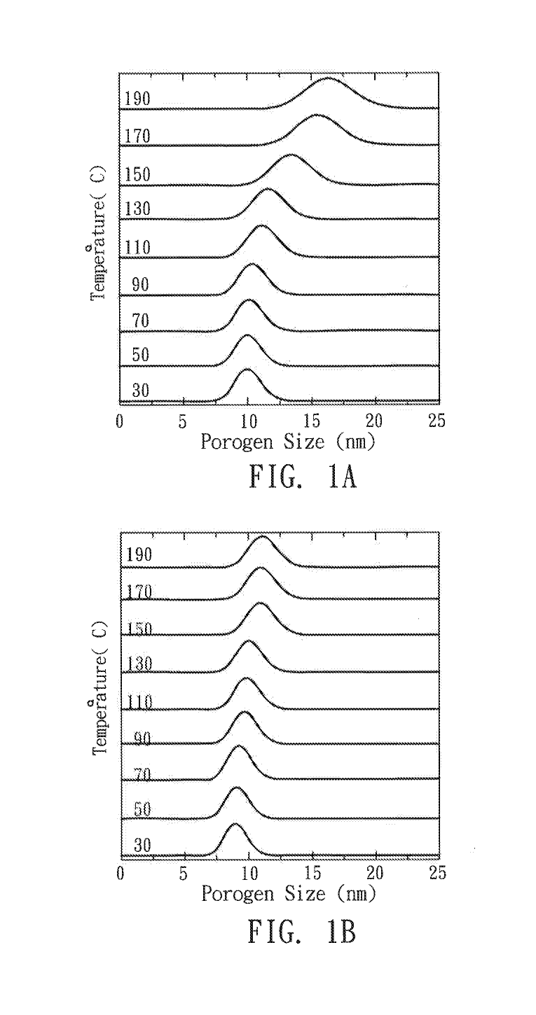

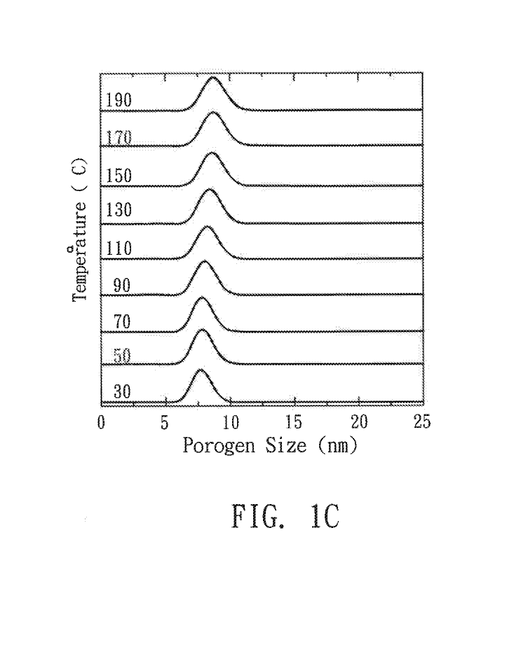

Referring now to FIGS. 1A, 1B and 1C, the figures show respectively the relationship between porogen size and temperature during the film curing step for PS porogens with and without NaDBS and DB modification, For the porogen without modification, the porogen size increased from 10.0±2.4 nm to 16.5±5.5 nm. Particularly, the increased rate of porogen size became noticeable at 110° C. In contrast, the porogen size of the NaDBS modified porogen increased slightly from 9.0±2.0 nm to 11.1±2.4 nm, and the porogen size of the DB modified porogen changed only slightly from 7.8±1.0 nm to 8.7±2.0 nm. Overall, modification of PS porogen by DB yielded the smallest porogen size and tightest distribution during the curing step.

Through GISAXS analysis, it can be confirmed that smaller and uniform pores in the porous films were prepared after removing NaDBS and DB modified PS porogens. Specifically, the pore sizes were calculated to be 16.8, 11.5, and 8.8 nm for these 3 different systems (i.e. porogens without modification, with NaDBS modification, with DB modification). Table 2 below shows the PS particle sizes and pore sizes. In addition, the porosity of the porous film at 10 wt % PS loading was found to be about 15.6% by using the XRR technique.

TABLE 2

| | PS Particle Size | PS Particle Size | Pore Size |
|---|---|---|---|
| | under | under 210° C. | under |
| Treatment on PS | 30° C. (nm) | (nm) | 400° C. (nm) |
| No Modification | 10.0 | 16.5 | 16.8 |
| Anionic Surfactant | 9.0 | 11.1 | 11.5 |
| NaDBS | | | |
| Cationic Surfactant | 7.8 | 8.7 | 8.8 |
| DB | | | |

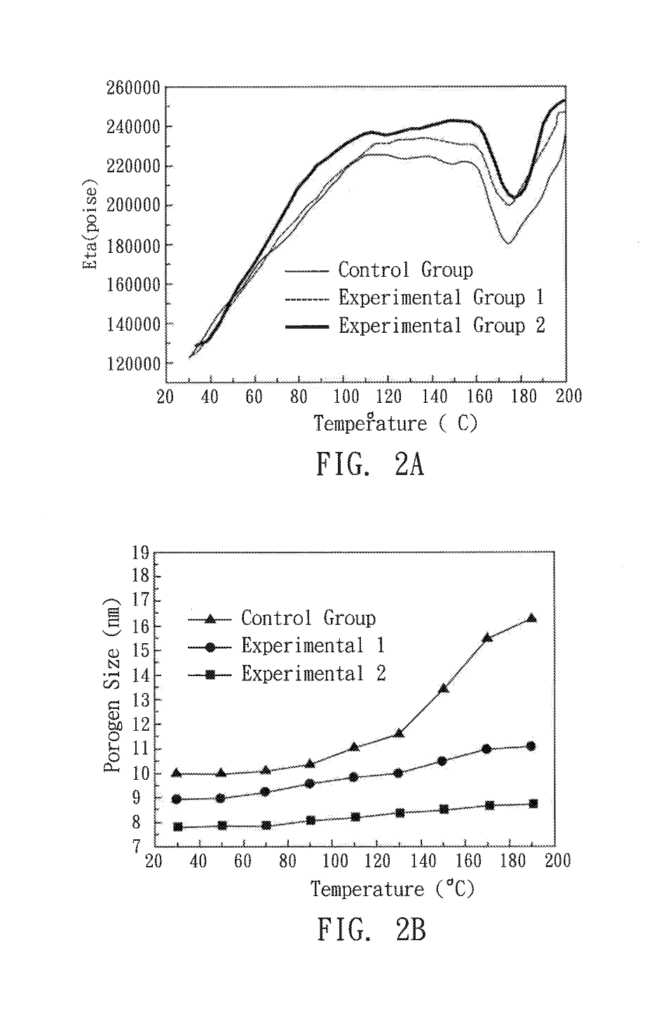

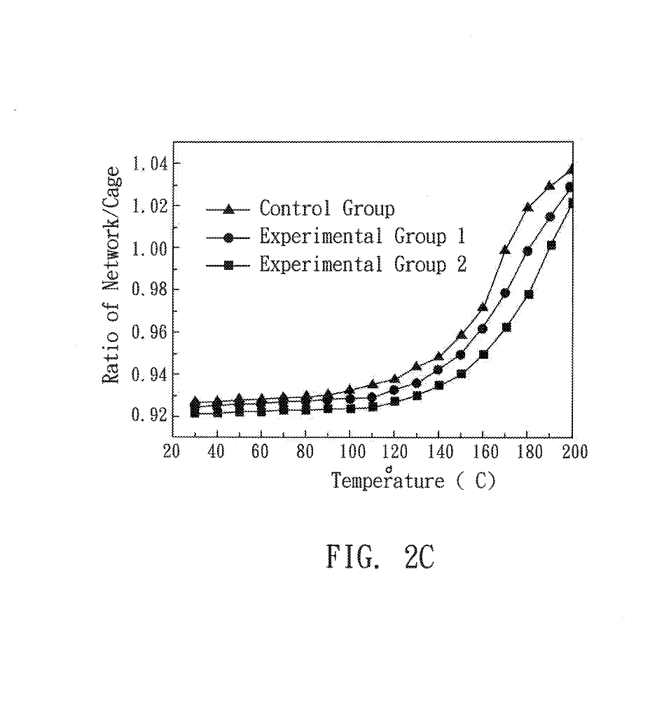

Referring now to FIGS. 2A, 2B and 2C, the figures show the viscosity, PS size and degree of network/cage of the films having porogens without modification (control group), with NaDBS-modification (experimental group 1) and with DB-modification (experimental group 2). The result shows the following: PS porogen can aggregate readily at a temperature between the glass transition temperature (T_{g}) and 160° C. in the control group. The aggregation was enhanced at T>160° C. due to viscosity reduction by H₂O released from cross-linking of the MSQ matrix. At T>175° C., viscosity increased again as the cross-linking of the MSQ matrix was near completion, leading to a continued increase in porogen size to 16.5 nm. In the experimental group 1, the figure shows that the PS porogen size can increase very little and it exhibits higher viscosity (about 2.3×10⁵ poises) than the control group (about 2.2×10⁵ poises) in the 105° C.-160° C. range, namely lower cross-linking degree than the control group. Moreover, very slight change and the higher viscosity (about 2.3×10⁵ poises) than the experimental group 1 (namely, the lowest degree of cross-linking) were observed in the experimental group 2.

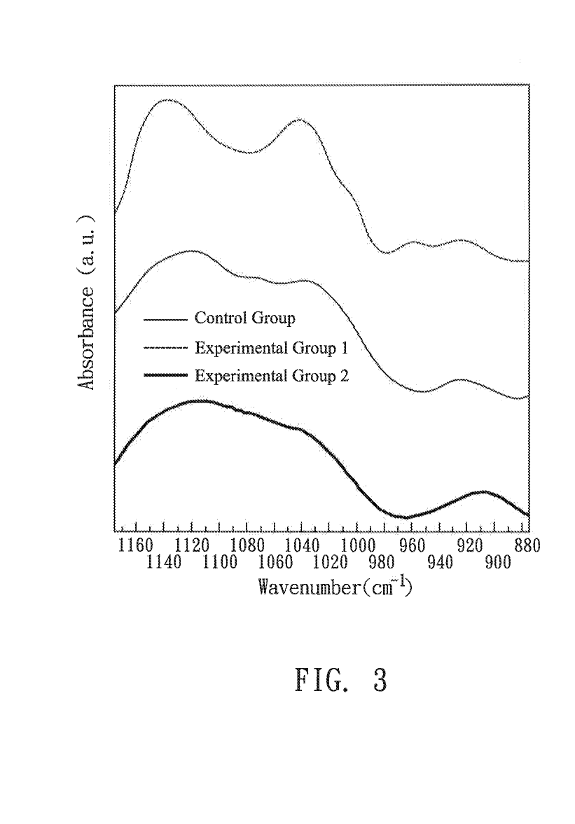

As shown in FIG. 3, the changes in the of Si—OH infrared absorption band in the 905-930 cm⁻¹ region of the films were investigated. The peak positions of Si—OH for the unmodified (control group), NaDBS-(experimental group 1), and DB-modified PS systems (experimental group 2) were 922, 924, and 908 cm⁻¹, respectively. Compared to the control group and the experimental group 1 with a negative surface potential, the experimental group can exhibit a positive surface potential and the strong red shift (14 cm⁻¹) in the Si—OH band owing to columbic attraction between the electron lone pair of oxygen atoms and the positively charged PS particles.

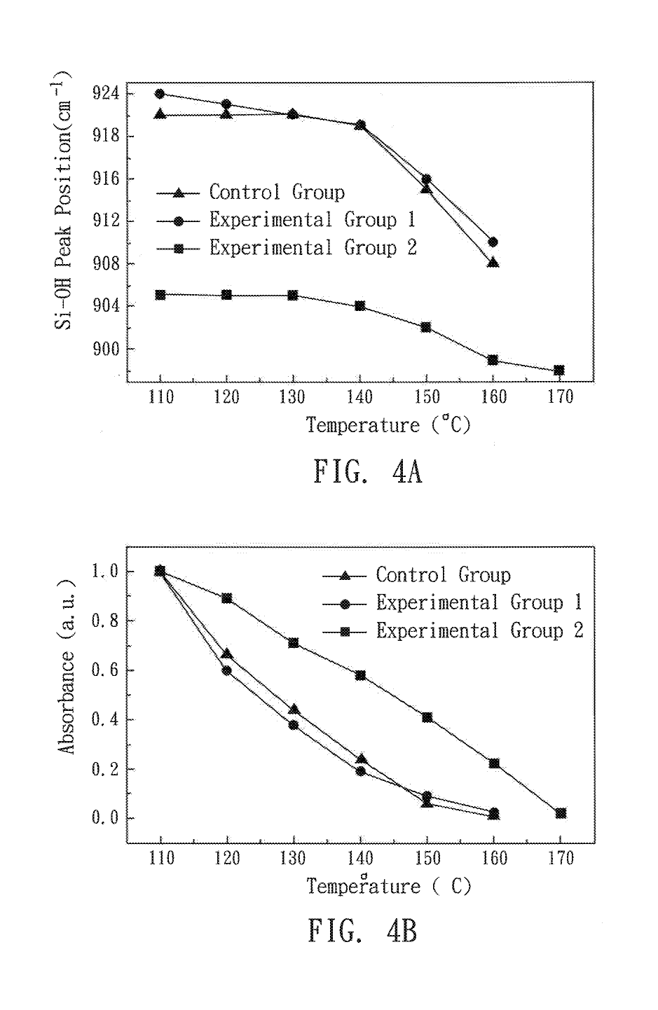

FIGS. 4A and 4B show the peak positions and peak intensities of the Si—OH absorption band of porogens without modification (control group), with NaDBS modification (experimental group 1) and with DB modification (experimental group 2), respectively. FIG. 4A shows that the electrostatic force between charged PS and MSQ is not affected by the temperature below 140° C. The peak positions of the control group and the experimental group 1 then shifted noticeably to 908 cm⁻¹ at temperatures between 140° C. and 160° C. This can be attributed to the hydrogen bonding interaction as Si—OH groups come in a closer range due to a drop of viscosity, starting the red-shift phenomenon. FIG. 4B shows that the decreasing rate of the Si—OH peak intensity is slower for the experimental group 2. This is due to the red-shift of the Si—OH band more greatly influenced by the positively charged PS.

Accordingly, the porogen can be trapped within MSQ by the attractive interaction between the positively charged porogens with cationic modification and the negatively charged MSQ with Si—OH groups before the removal of porogen, so as to finally formulate small size and uniform pores.

Although the present invention has been explained in relation to its preferred embodiment, it is to be understood that many other possible modifications and variations can be made without departing from the spirit and scope of the invention as hereinafter claimed.

What is claimed is:

1. A method for preparing a porous material, comprising the steps of:
(A) providing a substrate;
(B) coating a precursor solution to form a precursor film on the substrate, wherein the precursor solution comprises a precursor compound, a porogen, and a solvent, and the porogen is treated with surface modification to have an absolute value of surface potential greater than 25 mV; and
(C) heat curing the precursor film, and removing the porogen to form a porous material.

2. The method for preparing a porous material as claimed in claim 1, wherein the precursor compound is a low-k matrix precursor, or a metal catalyst precursor.

3. The method for preparing a porous material as claimed in claim 2, wherein the low-k matrix precursor is selected from the group consisting of methyl silsesquioxane (MSQ), poly methyl silsesquioxane (PMSSQ), poly silsesquioxane, benzene and biphenylene-bridged silsesquioxane, 1,2-bis(triethoxysilyl) ethane (BTESE), methyl triethoxysilane (MTES), and alkoxysilane.

4. The method for preparing a porous material as claimed in claim 3, wherein the low-k matrix precursor is methyl silsesquioxane (MSQ).

5. The method for preparing a porous material as claimed in claim 1, wherein the porogen is selected from the group consisting of a polymer having low decomposition temperature, a polymer having high decomposition temperature, a dendrimer, an amphiphilic linear polymer, a star-shape polymer, a hyperbranched polymer, and a cage supramolecule.

6. The method for preparing a porous material as claimed in claim 5, wherein the porogen is selected from the group consisting of polymethylmethacrylate (PMMA), polystyrene (PS), ethyl acrylate-terminated polypropylenimine, polymethylmethacrylate-poly(2-dimethylaminoethyl methacrylate) (PMMA-PDMAEMA), poly(ethylene oxide)-poly(propylene oxide)-poly(ethylene oxide) (PEO-PPO-PEO), polystyrene-poly(styrene-β-2-vinyl pyridine) (PS-P2VP), poly(e-caprolactone) (PLCs), and cyclodextrin (CDs).

7. The method for preparing a porous material as claimed in claim 6, wherein the porogen is polystyrene (PS).

8. The method for preparing a porous material as claimed in claim 1, wherein the solvent is selected from the group consisting of tetrahydrofuran (THF), butanol, ethylene glycol, toluene, methyl isobutyl ketone (MIBK), dimethylformamide, ethanol, hexane, chloroform, and acetone.

9. The method for preparing a porous material as claimed in claim 8, wherein the solvent is tetrahydrofuran (THF).

10. The method for preparing a porous material as claimed in claim 1, wherein the porogen treated with surface modification has an absolute value of surface potential of 50 to 70 mV.

11. The method for preparing a porous material as claimed in claim 1, wherein the surface modification is performed by an acidic solution, a basic solution, or a surfactant, to change surface potential of the porogen.

12. The method for preparing a porous material as claimed in claim 11, wherein the surfactant is a cationic surfactant, or anionic surfactant.

13. The method for preparing a porous material as claimed in claim 12, wherein the cationic surfactant is domiphen bromide (DB), or hexadecyl trimethyl ammonium bromide.

14. The method for preparing a porous material as claimed in claim 12, wherein the anionic surfactant is sodium dodecylbenzene sulfonate (NaDBS), sodium dodecyl sulfate (SDS), or sodium lauryl sulfate (SLS).

15. The method for preparing a porous material as claimed in claim 1, wherein in step (C), the heat curing is to raise temperature up to 400° C. at a rate of 2° C. per minute.
